(19) United States
(12) Patent Application Publication
(10) Pub. No.: US 2012/0272843 A1
(43) Pub. Date: Nov. 1, 2012

(54) PRESS HAVING A DIRECTLY DRIVEN CRANK MECHANISM, PRESS LINE COMPRISING PRESSES OF THIS TYPE, AND A METHOD FOR PRODUCING A PRESS HAVING AT LEAST ONE DIRECT DRIVE

(75) Inventor: Matthias Graff, Bretten (DE)

(73) Assignee: DIEFFENBACHER GMBH MASCHINEN-UND ANLAGENBAU

(21) Appl. No.: 13/505,834

(22) PCT Filed: Oct. 30, 2010
(86) PCT No.: PCT/EP10/06648

§ 371 Date: Jul. 16, 2012

(30) Foreign Application Priority Data
Nov. 4, 2009 (DE) 10 2009 051 939.4

(51) Int. Cl. B30B 1/26; H02K 15/00; B30B 15/34

(52) U.S. Cl. 100/193; 100/282; 29/596

(57) ABSTRACT

A press having a directly driven crank mechanism, press line and method for producing a press having at least one direct drive. A press has at least one press frame, table mounted in the latter, and ram driven by means of at least one crank mechanism and die upper part and die lower part on the press table, at least one crankshaft having at least one crank pin and at least one connecting rod arranged as crank mechanism, and at least one direct drive which drives the crankshaft directly and comprises at least one rotor and one stator arranged as motor for the drive of the crankshaft. At least the stator of the motor comprises at least two power carriers, the power carriers are configured as independent and exchangeable structural units, the power carriers are arranged radially with respect to the crankshaft, and the power carriers are operatively connected individually or in sections to a control unit by supply lines.

The invention relates to a press having a directly driven crank drive according to the preamble of claim 1. Furthermore, the invention relates to a press line having such presses according to the preamble of claim 9. In addition, the invention relates to a method for producing a press having at least one direct drive according to the preamble of claim 14.

Manufacturing machines having a reversing ram typically have a motorized drive and a crank drive, which converts the rotational movement of the drive into a linear and reversing movement. Such manufacturing facilities are typically used as presses for reshaping or cutting workpieces. In particular the automobile industry requires press lines, consisting of multiple presses arranged one behind another and an associated transport system, in order, for example, to manufacture complicated geometries, such as fenders, vehicle doors, catalytic converter envelopes, and many other parts from simple delivered coils (flat strip rolls made of metal).

In particular rapidly running press facilities are implemented as mechanical presses as described above.

Many different terminologies have become established in the prior art, so that several terms used herein will be explained and the most well-known synonyms thereof will be described without claiming completeness.

A crank drive according to the invention is a drive which can reshape a rotational movement (of a motor) into a linear movement and is reflected in the technical literature as an eccentric drive or slider crank drive or the like. As explained above, the main task of the crank drive is the conversion of a rotational movement into a translational movement, an eccentric shaft or, as hereafter, a crankshaft being used. An eccentric pin or, hereafter, crank pin is mounted located on the crankshaft outside the rotational axis of the crankshaft, a push rod, referred to hereafter as a connecting rod, typically being arranged on the crank pin. The force flow of the drive can extend from the smallest possible denominators of the crank drive, a crankshaft and a crank pin, up to a ram via multiple stations such as slider cranks, articulated drives, inter alia, or also only one connecting rod.

Furthermore, the term press frame stands for the supporting framework of the press. As defined in the invention, this comprises all press frames in their possible embodiments, for example, constructed press frames made of multiple individual parts (crosshead top and bottom, side columns) and also press frames in window frame design or in tie rod construction. Direct drives and servo presses are distinguished in that various speed gradients may be set via a press stroke (OT-UT-OT) through the use, preferably, of DC motors. A pendulum stroke drive is also possible without an ever present danger of overload of partially complex gearwheel or crank drives, if these are provided.

A drive system for a reshaping machine is known from DE 28 40 710, which discloses a direct drive for a drive system of a press. The shaft output of the direct drive has a transmission ratio via a transmission even before the drive force can be transmitted via the shaft to a crank disc and finally to a crank pin.

A direct drive is also known from DE 102 60 127 A1, which is externally flanged onto a shaft and outputs its drive force directly to the crankshaft without the aid of a step-down transmission.

All of these disclosures display a severe disadvantage, that the motor is arranged outside the supporting structures of the press or the press head, respectively. The motor is typically connected for this purpose to the main drive shaft via a clutch or by direct placement on the main drive shaft (flange, clamping set, or splined shaft).

A further problem is that in particular large reshaping presses having high tonnage of pressing force require one or more strong motors. In reshaping presses, these are typically located in the press head (above the ram) and drive one or more crankshafts via gear wheels. These motors are designed in their power consumption for the highest load case and can only be replaced in one piece if they are defective. It is typically provided that the motor can be lifted upward by means of a crane. In presses having an arrangement of the motors within the press head or laterally thereto, respectively, for facility reasons, this is not possible, for example.

The object of the invention comprises providing a press in which the above-mentioned disadvantages are decreased or even prevented. In particular, it is to be possible to provide a press production series, which can be downgraded or upgraded with different drive performances rapidly and easily, and in which in particular the motors can be repaired simply and rapidly by replacement of essential drive elements.

Furthermore, a press line is to be provided, which, in the case of a substantially similar press construction of the individual presses because of a possible press production series, similar motors and/or motor mounts are used in the direct drives, which may be very easily and cost-effectively varied with respect to their required power, however. It is simultaneously to be made possible that the presses can be refitted easily for other tasks with respect to their drive power.

Finally, a method for producing a press is to be provided, which has a direct drive, which can be installed centrally on at least one crankshaft within or on a press frame.

The achievement of the object for a press according to the invention is that at least the rotor, with or without at least a part of the crankshaft, is moved into the at least partially installed press and is held temporarily or is arranged ready for operation essentially in the area of the motor, and subsequently the stator is produced by installing individual power providers or by installing a prefinished installation group made of at least two power providers in the area of the motor.

The achievement of the object for a press line is that at least two presses having a direct drive are arranged in the press line, at least two power providers being arranged in the motors of each direct drive in the stator.

A press line is essentially distinguished in that a workpiece passes through the individual presses in a predefined sequence, the workpiece preferably being moved between the presses by a transfer device.

The achievement of the object for a method according to the invention for producing a press having at least one direct drive is that at least the rotor is moved with or without at least a part of the crankshaft into the at least partially installed press and is held temporarily or is arranged ready for operation essentially in the area of the motor, and subsequently the stator is installed by installing individual power providers or by installing a prefinished installation group made of at least two power providers in the area of the motor.

The following advantages result with the construction according to the invention: In the case of a preferred application of similar power providers in form, construction, and/or power consumption, the possibility results of improved installation capability, storage, and repair capability. In particular, it is possible in one press construction series to offer different power concepts (power consumption of the motors in kilowatts), which are also variable easily and without complication afterwards. For example, the power providers can be constructed so that, for example, even-numbered multiples of the power providers can be arranged around the periphery of a stator.

If, in an exemplary embodiment, 64 power providers each having 10 kW can be installed in one stator of a direct drive, a press series could be offered which offers a motor power of 640, 320, 160, or 80 kW, for example, so that a customer can order a small press at 160 kW and can later equip it for 320 kW or 640 kW without difficulties by purchasing further power providers. In this context, the repair may also be made easier, because in the event of disturbances or defects in the drive of a press, the entire motor no longer has to be replaced, but rather in the case of a defect of a power provider, only this power provider is still removed and replaced by a new power provider. Power providers are understood in the present invention in this context as, for example, a drive coil winding for the permanent magnets fastened on the rotor. The advantages may be illustrated even better in the case of a plurality of presses, for example, in a press line. Large press lines for mechanical reshaping of plates, for example, have multiple processing steps, which can comprise:

Single-step or multistep coarse reshaping, local deep-drawing areas, post-forming, stamping out openings and/or edge trimming, and folding edges. For example, if six presses are installed in a press line, the first press typically requires the most drive power to perform the coarse reshaping of the flat plate. The following presses then typically have a drive power which is reduced in relation to the first press. All of these presses may preferably be equipped with a drive system according to the invention in an advantageous manner and can nonetheless be used further without problems, for example, upon the change of a large production run of a model in automobile construction, in regard to the drive power. For example, if it becomes necessary to increase the drive power for a different large run in the third press, for example, the entire motor does not have to be replaced, but rather only the number of the power providers is increased. The power providers are independent and functional components and represent a drive unit or a motor per se. The special feature is thus that preferably a plurality of drive units or power providers are installed radially on the periphery in the meaning of a stator and act independently per se and can be replaced if needed individually or in segments in assemblies.

In particular, it is advantageous that the motor does not consist of one unit, but rather a plurality of units, which can accordingly be replaced or successively installed. This is useful in particular in the case of a tight installation space or special technical presses. Previous direct drives could therefore only be installed outside of or on the edges of a crankshaft, because the direct drives were delivered in one piece by the producer of the drives. However, the use of such a direct drive can also be advisable on the edges of a crankshaft or externally on the housing of a press, respectively, in particular with respect to graduated drive powers or the easy replacement of individual power providers. With the present invention it is now possible in particular to also arrange the direct drives inside a press frame, because the direct drive is installed in parts and can be replaced in sections without problems in the event of damage to the power providers or to the stator individual parts. In particular, it is provided that the power providers are preinstalled on prefinished segments, for example, four 45° elements to form a stator, and these four segments are then successively installed in the press or on the torque support. In a rotor having radially externally arranged permanent magnets, for example, the crankshaft can be placed in the press before or after the installation of the power providers, which is correspondingly advantageous for the construction progress of the press itself. A parallel installation, for example, two segments or multiple power providers, then the introduction of the shaft, and subsequently the final installation of the remaining elements, is also conceivable, of course.

The shaft is preferably first coarsely mounted in the press, then the remaining power providers are installed, and subsequently the alignment of the shaft or the rotor in relation to the partially or completely installed stator is performed.

In a special solution, the rotor is installed with already provided permanent magnets, optionally still without connection to a crankshaft or only to a part of the crankshaft, in the press, preferably in a part of the press such as the drive head or the drive area. The stator segments or individual power providers, respectively, are subsequently installed. If this has not already been performed during the installation, the crankshaft is installed and an alignment of the internal structure of the motor, i.e., of the rotor to the stator, is performed.

Advantages of a direct drive on the crankshaft:

Through the close construction of a direct motor in direct proximity to a connecting rod, varying load for the crankshaft can be relayed on the output side in a manner harmless to the system, the overall stiffness of the drivetrain being able to be significantly increased and/or the overall length of the drivetrain being able to be minimized simultaneously. The required installation space of the press having a direct drive can be substantially optimized and reduced in size, and simple measures may be implemented for noise damping of essentially the drivetrain by encapsulation. The press can be implemented having a short installation length, which is advantageous in particular in servo presses in press lines for the production of large vehicle body parts. In order to keep the transport paths between the presses as short as possible, the presses must stand closely one after another. The shorter the distance, the more rapid the transfer times. Large presses are typically implemented having an even number of two, four, . . . pressure points (connecting rod or articulated mechanism attachments) on the ram. The distances transversely and longitudinally between the pressure points or the connecting rods, respectively, cannot be selected arbitrarily, but must be selected according to aspects with regard to the reduction of the ram deflection. The safe absorption of off-center forces, in particular in the case of asymmetrical tool or workpiece geometries, is also decisive for the arrangement of the contact points of the connecting rods on the ram of the press. The length of the press head, typically in the passage direction, is determined by the connecting rod distance and the required construction of the main bearings and support structures.

Furthermore, in the advantageous arrangement of the direct drive, in particular within the required support structures of the press, a substantially stiffer drive system and, accompanying this, a reduction of the crankshaft torsion result. If the crankshaft is driven from the outside as the main drive shaft, the torsion of the crankshaft has a disadvantageous effect on the entire drive system. The longer the distance between motor and crank pin or eccentric eye, the softer the drive system, and regulating oscillations occur, because the crankshaft acts like a torsion spring. In the case of a pendulum stroke in particular, severe control and regulating difficulties occur. The readiness to oscillate of the entire drive system having corresponding problems for the support structures or the press frames, respectively, is also problematic and layout-intensive in the design of a press. In the case of a one-sided drive having two connecting rods or two crank pins, respectively, on a shaft, an angle offset also occurs, whereby the connecting rods assume different stroke locations. Improved control and regulation quality of the system is also displayed in this context through the advantages of the invention. Due to the high stiffness of the drive system and the precisely settable torque and angular position regulation of the motor, no measurable deviations result between two crank pins and therefore on the connecting rods on a crankshaft. The process data can additionally be acquired directly. The press does not have additional mechanical transmission elements (e.g., gear stages) due to the direct drive. The parameters measured on the motor, such as speed, torque, and angular location, can be converted without errors into ram speed, pressing force, and ram position. Corruption due to friction losses or torsion, tooth flank play, etc. is outstandingly eliminated.

Permanent magnet motors have quite a high noise level, in particular at a high drive power. Through the installation in the press head, the noise emission can be easily reduced through relatively simple measures, e.g., by closing the press head on the top and bottom sides.

The overall efficiency of the press is also significantly improved, because significantly fewer unused forces arise due to the torsion or the torque absorption in the bearing in the case of an overhung mounting of the motor. In a particular exemplary embodiment, the stator of the direct drive can be supported in the press head and/or can be provided with a corresponding torque support. In relation to a conventional direct drive, the motor therefore does not have a separate mounting and the mounting of the rotor within the stator is also taken over by the main mounting of the crankshaft. Therefore, additional losses no longer occur. In a particularly preferred exemplary embodiment, in particular in large presses of high tonnage, the direct drive is placed on the supporting part of the crankshaft, i.e., it is located between the main bearings of the mechanical drive which absorb the pressing force. The motor is then preferably also located between the main load-bearing support structures (at least two press frames of the press) and concentrically to the main drive shaft (crankshaft). The connecting rods, or in articulated drives, the pivot levers which lead to the connecting rods, can either be located on the right and left of the motor and therefore between motor and main bearings (support structure of the press head) or on one side between the motor and one of the main bearings.

Further advantageous measures and embodiments of the subject matter of the invention are disclosed in the subclaims and the following description with the drawing.

In the schematic figures:

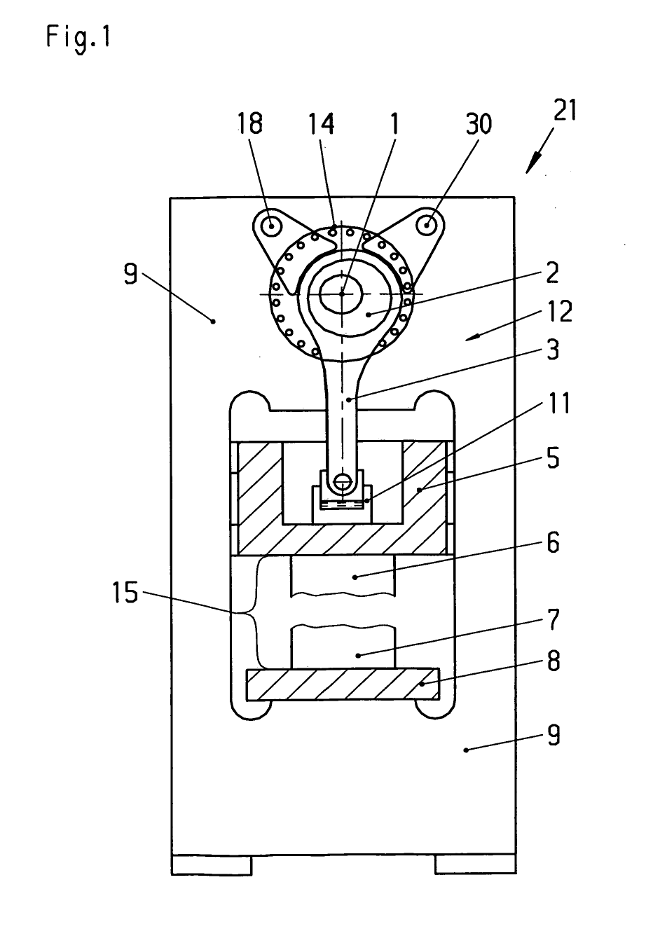

FIG. 1 shows a mechanical press having a press frame and a press table, in the upper area of the press, in the head area, the drive system being located, consisting of two crank drives arranged one behind the other, each having a crankshaft, a crank pin, and a connecting rod operationally linked to a ram,

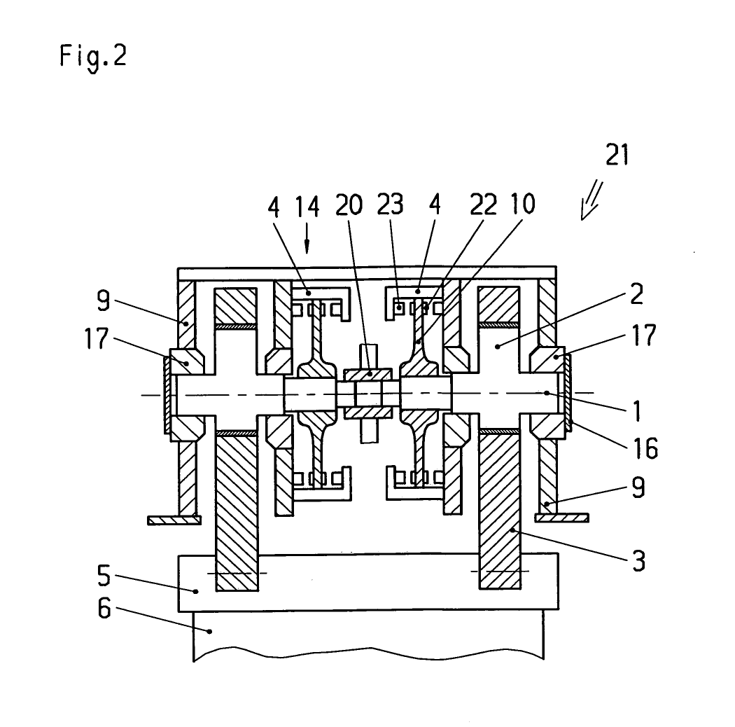

FIG. 2 shows the same embodiment in a side view according to FIG. 1, with illustration of the two crank drives arranged adjacent to one another, one separate direct drive per crank drive being arranged for the separate drive,

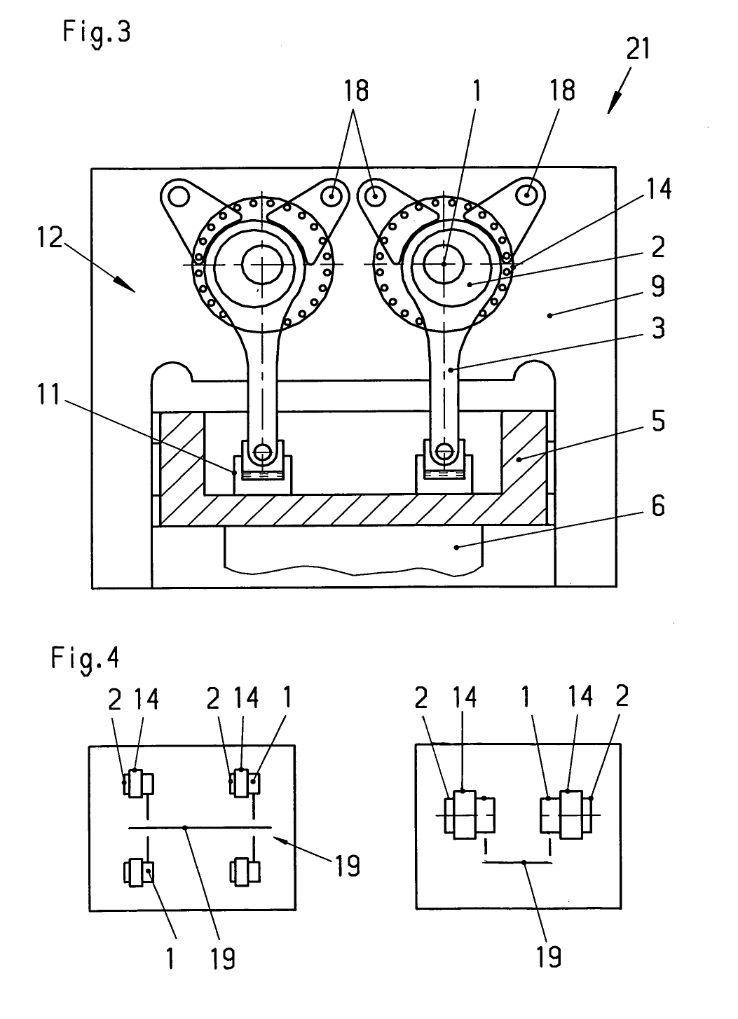

FIG. 3 shows a further possible embodiment having four driven connecting rods, two crank drives again being arranged one behind the other,

FIG. 4 shows two illustrations of possible forced couplings for parallel running of the ram in a top view for the examples according to FIG. 3 (on the left) and FIGS. 1 and 2 (on the right),

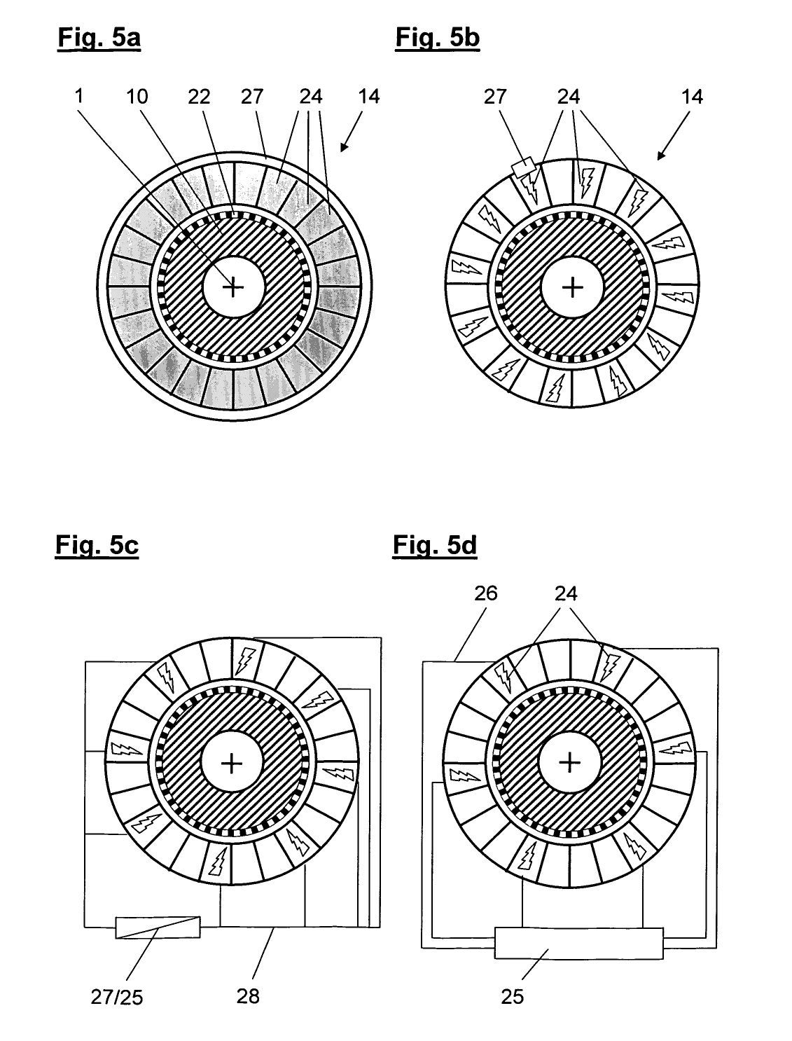

FIG. 5 shows four schematic sectional views of a direct drive consisting of a stator and a rotor on a crankshaft having different numbers of the power providers,

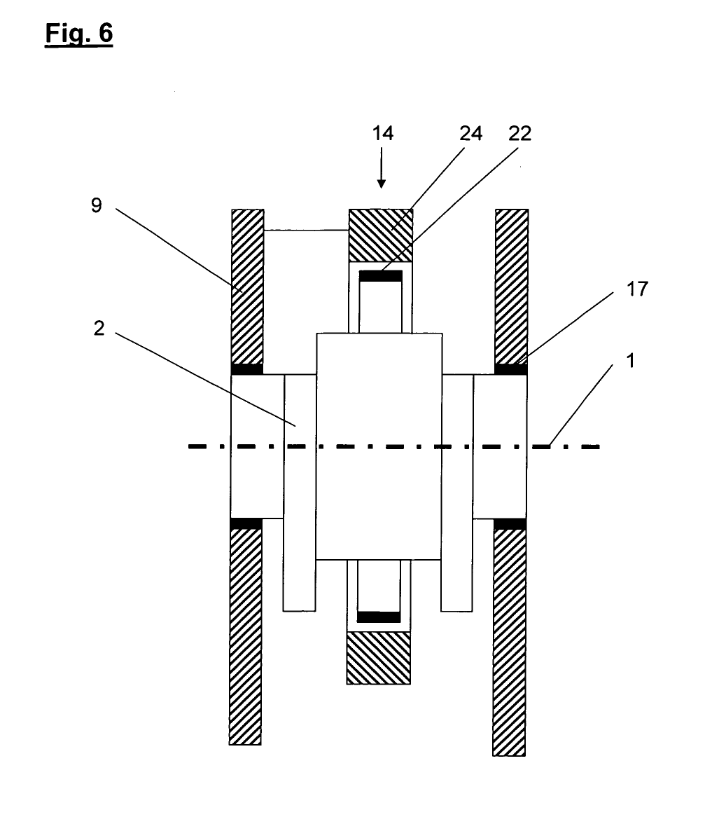

FIG. 6 shows a schematic view of a directly driven crankshaft having permanent magnets arranged radially externally on the rotor, and

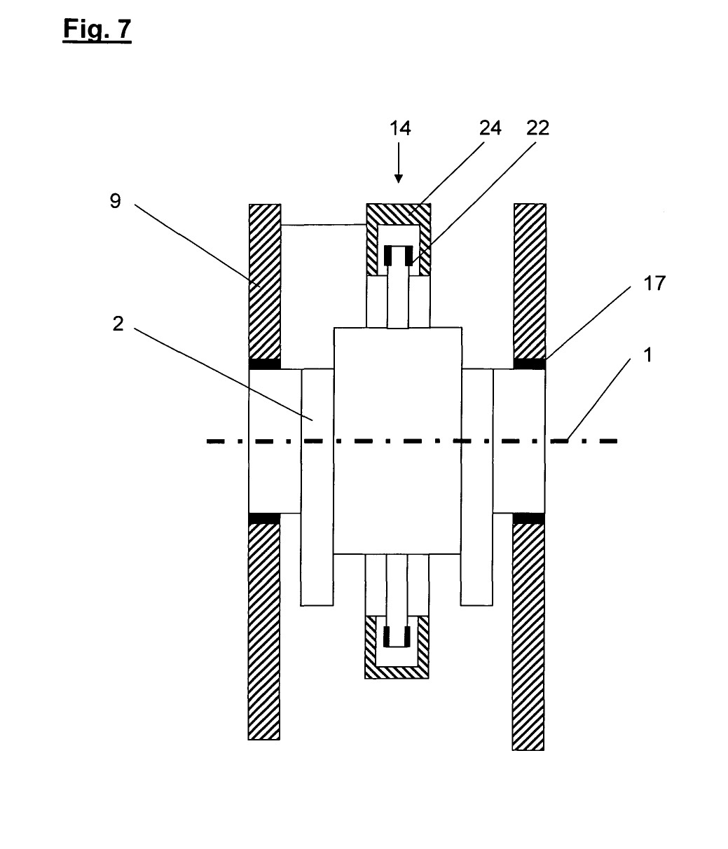

FIG. 7 shows a schematic view according to FIG. 6 having two rows of arranged permanent magnets, which are enclosed by U-shaped power providers.

According to FIG. 1, the press 21 consists at least of a press frame 9, a press table 8 mounted therein, and a ram 5 driven by means of at least one crank drive 12. This press 21 is preferably used for breaking in tools 15 or for producing workpieces (not shown) by means of at least one manufacturing method in a tool 15, the tool consisting at least of a tool top part 6 on the ram 5 and a tool bottom part 7 on the press table 8. At least one crankshaft 1 having at least one crank pin 2 and at least one connecting rod 3 is arranged as the crank drive 12, as the motor 14 for the drive of the crankshaft 1, at least one direct drive, which directly drives the crankshaft 1 and is mounted in a mount 18, being provided. In the crank drive 12, which is also referred to as an eccentric drive, instead of the connecting rod 3 or between the connecting rod and the crank pin, an articulated drive or a slider crank or similar intermediate devices can be arranged, which are typically used for stroke height adjustment, for safety reasons, or to set the sinus curve of the movement path of the ram. In particular to drive a toggle lever drive, an articulated drive, a further crank drive, or a combination thereof, the crank drive 12 is arranged operationally linked thereto, these in turn being arranged operationally linked on the output side to the ram 5.

FIG. 2 shows the same embodiment in a side view according to FIG. 1. In this special exemplary embodiment, the motors 14 are arranged as a direct drive between the connecting rods 3 of the individual ram attachments. In the present example, the two connecting rods are located on two separate crankshafts 1, which are mounted accordingly in the press frame 9 of the press 21. A possibly required forced coupling 19 between the two connecting rods is not shown for reasons of clarity and is located, for example, in the right drawing of FIG. 4. It is obvious from FIG. 2 that the motors 14 consist of a stator 4 arranged on the press frame 9 and a rotor 10 arranged on the crank drive 12, or the crankshaft 1, respectively. In an advantageous manner and to optimize the center of gravity of the press 21, both drives are arranged between the connecting rods here. This also results in advantages in particular in the lines of the motors 14, which are effectively kinematically separated from one another by an intermediate bearing 20 mounted in the press frame 9. In an alternative, the crankshaft can also be made continuous, of course, and only one motor 14 or even multiple motors can be arranged, depending on the specifications of the press 21. A forced coupling of the two crankshafts 1 can be implemented as a coupling axis arranged parallel to the crankshaft 1 having corresponding spur gear connection to the individual crankshafts or can be implemented as a direct frontal connection of the two crankshafts. This does not necessarily have to be arranged inside the intermediate bearing 20. Furthermore, advantageous embodiments of the press 21 are found as separate bearings 17, which are arranged in corresponding large installation openings of the press frame 9 and have a bearing cover 16.

Two illustrations of possible forced couplings for parallel running of the ram in a top view for the examples according to FIG. 3 (on the left) and FIGS. 1 and 2 (on the right) are shown in the two drawings of FIG. 4. The drives or the motors 14 are at least partially, but particularly preferably completely arranged between the connecting rods 3, or their crank pins 2, respectively. The forced coupling can be implemented via mechanical spur gears having corresponding engagement possibilities on spur wheels of the crankshafts 1. Alternatively or in combination, electronic forced coupling of the frequency rectifiers or the control unit, respectively, can be implemented for the motors 14.

Further preferred exemplary embodiments are mentioned hereafter, which, furthermore, do not necessarily have to be implemented in detail in the drawing. Thus, the motor 14 is arranged substantially adjoining, at least adjacent to, or preferably in one piece with a crank pin 2 on the crankshaft 1. Depending on the embodiment and definition location, a so-called crank disc can be integrated within or on the motor. The stator 4 of the motor 14 is preferably implemented so that it takes over the function of the crank disc and guides the crank pin 2 outside the center axis of the crankshaft 1. A mount 18, which is connected to the press frame 9, is provided for torque compensation and/or mounting of the motor 14. The motor 14 can be implemented as a direct drive of a stator 4 having a drive winding 23 and a rotor 10 arranged therein having permanent magnets 22 and would then be implemented as a permanent magnet motor. Fundamentally, in the case of at least two crank pins 2 on the crankshaft 1, at least one motor 14 can be arranged between the crank pins 2. In particular in the case of a plurality of motors or crank pins 2, a symmetrical arrangement within the press 21 or the crankshaft 1 is preferred. It can thus be provided that in the case of multiple motors 14 and multiple crank pins 2, at least two motors 14 are arranged symmetrically to one of the center axes of the press frame 9 and/or one of the center axes of the ram 5 and/or to the longitudinal center point of the crankshaft 1 and/or to the arrangement of the crank pins 2 on the crankshaft 1. It would also be advantageous if the rotor 10 of the motor 14 and the crankshaft 1 and/or the crank pin 2 consist of a one-piece machine element. A height adjustment for the stroke of the ram 5 can also be arranged in the crank drive 12. An overload safety 11 is to protect the press from greater damage in the event of interference and decouples the connecting rod 3 from the ram 5 in case of damage. For torque compensation, the stator 4 of a motor 14 can be arranged on a bearing on the rotor 10 and a torque support having connection to the press frame 9 can appear advisable for compensation of the occurring torques on the stator 4. In particular if two crankshafts 1 are arranged, each stator 4 of one motor 14 can be arranged on one bearing on the rotor 10 and, for compensation of the occurring torques on the stators 4, a torque support having connection to the motor 14 can be arranged on the adjacent crankshaft 1, which allows mutual support of the torques. This has advantages in particular with respect to the vibration transmission to the press frame 9. As shown, the motor 14 and the crank drive 12 can be arranged inside a support structure formed by the press frame 9, which is preferably designed for a pressing force of greater than 200 tons, more preferably greater than 500 tons, particularly preferably greater than 800 tons. In particular in such presses, the stroke of the ram 5 is possibly greater than 300 mm, preferably greater than 600 mm, particularly preferably greater than 900 mm. The press 21 is preferably used for a manufacturing method, which at least comprises the shaping, isolation, joining, coating, and/or reshaping, in particular metal reshaping. In particular, the press 21 can be arranged as a head press or as an breaking-in press for tools of a press line and/or as at least one transfer press in a transfer press line and/or as a pre-press in the manufacturing direction before a transfer press line.

The bearings 17 of the crankshaft 1 are preferably arranged in bearing shields, which are removable from the press frame 9, so that an opening having an installation diameter in the press frame can be opened, which with respect to the diameter preferably is equal to or greater than the diameter of the rotor 10 on the crankshaft 1 or respectively corresponds to the largest diameter on the crankshaft 1. It can be helpful during the installation that a crankshaft 1 which is divided at least once in the longitudinal axis is arranged in the press, which has, for example, a flange connection, removable bearing pins, or a shaft/hub connection. The rotor 10 is particularly preferably permanently arranged on the crankshaft 1. For this purpose, a shrink fit, a welded connection, a soldered connection, a friction welded connection, a glue joint, and/or another inseparable joint bond can be used for connecting the rotor 10 to the crankshaft 1. A preferred embodiment of the rotor 10 would comprise grooves and/or depressions for accommodating the permanent magnets 22. Only after the manufacturing of the one-piece machine elements are these magnets to be inserted therein.

In particular in the case of two separate but axially aligned crankshafts 1, at least one motor 14 is to be arranged as a direct drive between the connecting rods 3. In the case of demanding geometries of the connecting rod arrangements, it would be advantageous if, in the case of two separate crankshafts 1, which are located in one plane, however, according to a coaxial projection of the two axes of the crankshafts 1 in one axis, at least one motor 14 is arranged as a direct drive between the connecting rods 3. A coaxial projection is understood to mean that the two coaxially arranged axes of the spaced-apart crankshafts are displaced parallel to one another until they are located in one axis. It may thus also be recognized here when a direct drive is arranged “between” two crankshafts, even if these crankshafts are not in one piece.

FIG. 5 shows four schematic sectional views of a direct drive consisting of a stator and a rotor on a crankshaft having different numbers of the power providers. The stator 4 of the motor 14 consists of twenty-eight (FIG. 5a), twelve (FIG. 5b), eight (FIG. 5c), or alternately six (FIG. 5d) power providers 24, which are implemented as independent and exchangeable units. The power providers 24 are arranged radially to the crankshaft 1 and the power providers 24 are operationally linked individually or sectionally to a control unit 25 by means of supply lines 26. The areas which are not marked by a lightning sign and are therefore free for optional power providers 24 are depicted for clarity and for better illustration of the power providers 24, which are exchangeable with one another. Of course, it is also conceivable that three power providers 24 are always arranged adjacent one another while leaving open one free area. In particular, it is advantageous if, in the case of multiple power providers 24, at least two power providers 24 having an equivalent performance and/or an equivalent external shaping are arranged. Shaping is understood as the external dimensions or the arrangement of significant installation elements. The power providers 24 are preferably arranged in groups of at least two. The possibility of connecting the power providers 24 directly or indirectly via a suitable mount 18 to the press frame 9 is not shown. FIGS. 5b and 5c show the possibility that at least one cooling device 27 is arranged either centrally on the stator 4 or on at least one power provider 24.

The individual supply lines and their exemplary pathway to a control unit 25, which preferably consists of at least one frequency converter, are shown in FIGS. 5c and 5d. In FIG. 5c, the supply lines 26 are combined into supply segments 28 and are alternately supplied directly or to a combined station of control unit 25 and cooling device 27. This is advisable in particular if the control unit 25 also requires continuous cooling.

The following special embodiments are not shown in the figures:

In the case of an indirect arrangement of the stator 4 on the press frame 9 of the press 21, at least parts of the stator 4 are arranged on a one-piece or multipart torque support, which is operationally linked to the press frame 9, and

at least parts of the stator 4, a torque support, and/or supply lines 25 form an installation unit.

If a press 21 according to the invention is used in a press line, at least two presses 21 having a direct drive are arranged, at least two power providers 24 being arranged in the motors 14 of each direct drive in the stator 4. The drives in the presses 21 preferably have different drive powers of the direct motors through arrangement of a different number of power providers 24. The direct drive of the head press arranged at the front in the manufacturing direction particularly preferably has a higher power than the following press. As already mentioned, at least two direct drives are to be arranged in one or more presses 21 of the press line having equivalent power providers 24, which makes the storage of replacement parts and also the production of a press 21 significantly more cost-effective, in particular if a different number of the power providers 24 are arranged in the stators 4 of the direct drives between the individual presses 21 of a press line.

FIGS. 6 and 7 show a typical and particularly preferred embodiment of the direct drive. In FIG. 6, a motor 14 is arranged as a direct drive on a crankshaft 1, which has two crank pins 2 and is mounted in bearings 17 in the press frame 9. The rotor having permanent magnets 22 on the periphery is arranged on a central element, preferably on the largest diameter of the crankshaft 1. A stator 4, which has multiple drive units or power providers 24, respectively, is arranged directly opposite and coaxially to the crankshaft. According to FIG. 7, the power providers 24 are implemented as U-shaped, the stator 4 having the permanent magnets arranged thereon engaging in the opening of the U-shaped power provider 24. The permanent magnets 22 are particularly preferably arranged on both sides on the axial exterior front sides of the rotor 4, respectively. The power providers 24, in their property for providing a drive torque in relation to the permanent magnets, preferably have drive windings or coils, through which current flows.

With respect to a method (not shown in greater detail) for producing a press 21, at least the rotor 10 is moved without or at least with a part of the crankshaft 1 into the at least partially installed press 21 and is held temporarily or is arranged ready for operation essentially in the area of the motor 14, the stator 4 subsequently being produced by installing individual power providers 24 or by installing a prefinished installation group made of at least two power providers 24 in the area of the motor 14. The power providers 24 are particularly preferably connected individually or in sections to a control unit 25 by means of supply lines 26. Particularly preferably, in the case of an indirect arrangement of the stator 4 on the press frame 9 of the press 21, at least parts of the stator 4 can be arranged on a one-piece or multipart torque support, which is operationally linked to the press frame 9.

### LIST OF REFERENCE NUMERALS: DP 1394

1 crankshaft
2 crank pin
3 connecting rod
4 stator
5 ram
6 tool top part
7 tool bottom part
8 table
9 press frame
10 rotor
11 overload safety
12 crank drive
13
14 motor
15 tool
16 bearing cover
17 bearing
18 mount
19 forced coupling
20 intermediate bearing
21 press
22 permanent magnet
23 drive winding
24 power provider
25 control unit
26 supply line
27 cooling device
28 supply segment

1. A press having at least one press frame, a table mounted therein, and a ram driven by means of at least one crank drive for breaking in tools or for producing workpieces by means of at least one manufacturing method in a tool, a tool top part being arranged on the ram and a tool bottom part being arranged on the press table, at least one crankshaft having at least one crank pin and at least one connecting rod being arranged as the crank drive, and at least one direct drive, comprising at least one rotor and one stator, which directly drives the crankshaft being arranged as the motor for the drive of the crankshaft, wherein at least the stator of the motor comprises at least two power providers, the power providers are implemented as independent and replaceable units, the power providers are arranged radially to the crankshaft, and the power providers are connected individually or in sections to a control unit by means of supply lines.

2. The press according to claim 1, wherein, in the case of multiple power providers, at least two power providers having an equivalent power and/or an equivalent external shaping are arranged.

3. The press according to claim 1, wherein the power providers are arranged in groups of at least two.

4. The press according to claim 1, wherein the power providers are operationally linked directly or indirectly via a mount with the press frame.

5. The press according to claim 1, wherein at least one cooling device is arranged either centrally on the stator or on at least one power provider.

6. The press according to claim 1, wherein at least one frequency inverter is arranged as the control unit.

7. The press according to claim 1, wherein for an indirect arrangement of the stator on the press frame of the press, at least parts of the stator are arranged on a one-piece or multipart torque support, which is operationally linked to the press frame).

8. The press according to claim 1, wherein at least parts of the stator, a torque support, and/or supply lines form an installation unit.

9. A press line for producing and/or reshaping workpieces having at least two presses according to claim 1, wherein at least two presses having a direct drive are arranged in the press line, at least two power providers being arranged in the motors of each direct drive in the stator.

10. The press line according to claim 9, wherein different drive powers of the direct motors are arranged in the presses by arranging a different number of power providers.

11. The press line according to claim 9, wherein the direct drive of a head press arranged in front in a manufacturing direction has a higher power than a following press.

12. The press line according to claim 9, wherein at least two direct drives are arranged in one or more presses of the press line having equivalent power providers.

13. The press line according to claim 9, wherein a different number of the power providers are arranged in the stators of the direct drives between individual presses.

14. A method for producing a press having at least one press frame, a table mounted therein, and a ram, driven by means of at least one crank drive, for breaking in tools or for producing workpieces by means of at least one manufacturing method in a tool, a tool top part being arranged on the ram and a tool bottom part being arranged on the press table, at least one crankshaft having at least one crank and and at least one connecting rod being arranged as the crank drive, and at least one direct drive which directly drives the crankshaft, comprising at least one rotor and one stator, being arranged as the motor for the drive of the crankshaft, wherein at least the rotor is moved without or at least with a part of the crankshaft into the at least partially installed press and is held temporarily or is arranged ready for operation in an area of the motor, and subsequently the stator is produced by installing individual power providers or by installing a prefinished installation group made of at least two power providers in the area of the motor.

15. The method according to claim 14, wherein the power providers are connected individually or in sections to a control unit by means of supply lines.

16. The method according to claim 14, wherein, for an indirect arrangement of the stator on the press frame of the press, at least parts of the stator are arranged on a one-piece or multipart torque support, which is operationally linked to the press frame.
